(19) United States
(12) Patent Application Publication
(10) Pub. No.: US 2025/0309474 A1
(43) Pub. Date: Oct. 2, 2025

(54) SECONDARY BATTERY

(71) Applicant: TOYOTA JIDOSHA KABUSHIKI KAISHA, Toyota-shi Aichi-ken (JP)

(72) Inventors: Kodai SHINTANI, Toyota-shi Aichi-ken (JP); Masahiro YAMADA, Kariya-shi Aichi-ken (JP); Tomohiro NAKAMURA, Kariya-shi Aichi-ken (JP); Takayuki HIROSE, Kariya-shi Aichi-ken (JP)

(73) Assignee: TOYOTA JIDOSHA KABUSHIKI KAISHA, Toyota-shi Aichi-ken (JP)

(21) Appl. No.: 19/021,406

(22) Filed: Jan. 15, 2025

(30) Foreign Application Priority Data
Mar. 27, 2024 (JP) 2024-052474

(51) Int. Cl. H01M 50/477; H01G 11/26; H01M 4/02; H01M 50/105; H01M 50/119; H01M 50/46

(52) U.S. Cl. CPC H01M 50/477; H01G 11/26; H01M 50/105; H01M 50/119; H01M 50/46; H01M 2004/029

(57) ABSTRACT

A secondary battery has: an electrode module including an electrode laminated body having a plurality of positive electrode layers and a plurality of negative electrode layers laminated via a separator; an exterior member encasing the electrode module; and a metal member that is higher in surface hardness and greater in surface roughness than an outer surface at both ends of the electrode laminated body of the electrode module in a laminating direction and an inner surface of the exterior member, the metal member being provided between the electrode module and the exterior member.

### CROSS-REFERENCE TO RELATED APPLICATION

This application claims priority to Japanese Patent Application No. 2024-052474 filed on Mar. 27, 2024, incorporated herein by reference in its entirety.

### BACKGROUND

### 1. Technical Field

The present disclosure relates to a secondary battery.

### 2. Description of Related Art

WO2014/034350 discloses an electrode module that has the relation of μeff<μl between the effective static friction coefficient μeff between the outermost layer of an electrode laminated body and the inner layer of a laminate film exterior member and the static friction coefficient μl that is the greater one out of a static friction coefficient between a positive electrode and a separator and a static friction coefficient between a negative electrode and a separator.

### SUMMARY

It is possible to restrain damage of the laminate film exterior member due to vibration of the electrode laminated body, by adjusting the effective static friction coefficient μeff between the outermost layer of the electrode laminated body and the inner layer of the laminate film exterior member to be a predetermined value. However, when the outermost layer of the electrode laminated body is composed of, for example, Al (aluminum), processing for increasing the friction coefficient on the Al surface can affect, in some way, corrosion prevention processing and processing for improving sealing strength which are normally needed on the Al surface, and there is room for improvement.

In consideration of the aforementioned facts, an object of the present disclosure is to provide a secondary battery capable of restraining movement of an electrode laminated body inside an exterior member without surface processing normally performed on the electrode laminated body being affected.

A secondary battery according to the present disclosure in a first aspect has: an electrode module including an electrode laminated body having a plurality of positive electrode layers and a plurality of negative electrode layers laminated via a separator; an exterior member encasing the electrode module; and a metal member that is higher in surface hardness and greater in surface roughness than an outer surface at both ends of the electrode laminated body of the electrode module in a laminating direction and an inner surface of the exterior member, the metal member being provided between the electrode module and the exterior member.

In the secondary battery according to the present disclosure in the first aspect, between the electrode module and the exterior member encasing the electrode module, the metal member that is higher in surface hardness and greater in surface roughness than the outer surface at both ends of the electrode laminated body of the electrode module in the laminating direction and the inner surface of the exterior member is provided. Therefore, by convexities and concavities on surfaces of the metal member eating into the outer surface of the electrode module and the inner surface of the exterior member, friction forces on contact surfaces with the surfaces of the metal member can be increased as compared with the case of no interposition of the metal member. Thereby, movement of the electrode module inside the exterior member can be restrained. Moreover, since the outer surface of the electrode module is not processed, surface processing that is normally performed on the electrode module is not affected.

With the secondary battery according to the present disclosure in a second aspect, in the configuration according to the first aspect, the electrode laminated body may be configured by laminating a plurality of bipolar electrodes via the separator, each bipolar electrode having the positive electrode layer provided on one surface of a current collector body and the negative electrode layer provided on another surface of the current collector body, and the electrode module may include end part current collector bodies laminated respectively at both ends of the electrode laminated body in the laminating direction.

Conventionally, in the electrode module having the bipolar electrodes, when the end part current collector body is composed of, for example, Al, corrosion prevention processing and/or processing for improving sealing strength are performed on the Al surface which is the outer surface of the end part current collector body. In the electrode module having the bipolar electrodes, differently from an electrode module having a typical electrode laminated body, the friction force between the electrode module and the exterior member is needed to be increased while an electrification function of the principal surface of the end part current collector body is secured. For example, there is a possibility that the processing as above performed on the Al surface is affected in some way when processing for increasing the friction force on the Al surface, such as use of a resin adhesive agent thereon, is performed for the electrode module having the bipolar electrodes.

Therefore, in the secondary battery according to the present disclosure in the second aspect, the electrode laminated body may be configured by laminating the bipolar electrodes via the separator, and the electrode module may include the end part current collector bodies laminated respectively at both ends of the electrode laminated body in the laminating direction. Therefore, the metal member provided between the electrode module and the exterior member may increase the friction force between the surfaces of the metal member and both the outer surface of the end part current collector body and the inner surface of the exterior member. Thereby, movement of the electrode module inside the exterior member may be restrained without an electrification function on the principal surface of the end part current collector body being disturbed.

With the secondary battery according to the present disclosure in a third aspect, in the configuration according to the second aspect, the metal member may be provided between at least part of the end part current collector body and the exterior member.

In the secondary battery according to the present disclosure in the third aspect, since the metal member may be provided between at least part of the end part current collector body and the exterior member, when the metal member is provided on only a part of the outer surface of the end part current collector body, costs required for the metal member may be reduced. Moreover, when the metal member is provided on the whole outer surface of the end part current collector body, movement of the electrode module inside the exterior member may be more effectively restrained.

With the secondary battery according to the present disclosure in a fourth aspect, in the configuration according to any one of the first to the third aspects, the exterior member may be a laminate film obtained by overlapping film materials, and an inner film, of the laminate film, that is on the electrode module side and the outer surface at both ends of the electrode laminated body in the laminating direction may be constituted of an equivalent material.

In the secondary battery according to the present disclosure in the fourth aspect, the inner film, on the electrode module side, of the laminate film forming the exterior member and the outer surface at both ends of the electrode laminated body in the laminating direction may be constituted of an equivalent material, and the metal member that is higher in surface hardness and greater in surface roughness than the outer surface and the inner film may be provided between the inner film and the outer surface. Therefore, by convexities and concavities on the surfaces of the metal member eating into the outer surface and the inner film of the laminate film on the electrode module side, the friction forces on the contact surfaces with the surfaces of the metal member may be increased. Thereby, movement of the electrode module inside the laminate film may be restrained.

With the secondary battery according to the present disclosure in a fifth aspect, in the configuration according to any one of the first to the fourth aspects, the metal member may have a metal foil having a polishing processed layer on a surface, and a surface hardening layer provided on a surface, of the metal foil, that is on both end sides in a thickness direction.

In the secondary battery according to the present disclosure in the fifth aspect, since the metal foil constituting the metal member has the polishing processed layer on its surface, a rough surface having convexities and concavities may be formed on the surface of the metal foil. Moreover, since the metal member has the surface hardening layer on the surface of the metal foil, the aforementioned surface having convexities and concavities may be hardened, and the convexities and concavities of the metal member may be made easily eat into the outer surface of the electrode module and the inner surface of the exterior member.

As described above, the secondary battery according to the present disclosure may have an effect of being able to restrain movement of the electrode laminated body inside the exterior member without surface processing normally performed on the electrode laminated body being affected.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a sectional view of a secondary battery according to an embodiment of the present disclosure along the laminating direction;

FIG. 2A is an explanatory diagram for explaining forming steps of an exterior member in the secondary battery in FIG. 1;

FIG. 2B is an explanatory diagram for explaining the forming steps of the exterior member in the secondary battery in FIG. 1;

FIG. 2C is an explanatory diagram for explaining the forming steps of the exterior member in the secondary battery in FIG. 1;

FIG. 2D is an explanatory diagram for explaining the forming steps of the exterior member in the secondary battery in FIG. 1;

FIG. 2E is an explanatory diagram for explaining the forming steps of the exterior member in the secondary battery in FIG. 1;

FIG. 3A is an explanatory diagram for explaining steps of assembling the exterior member in the secondary battery in FIG. 1;

FIG. 3B is an explanatory diagram for explaining the steps of assembling the exterior member in the secondary battery in FIG. 1;

FIG. 3C is an explanatory diagram for explaining the steps of assembling the exterior member in the secondary battery in FIG. 1;

FIG. 3D is an explanatory diagram for explaining the steps of assembling the exterior member in the secondary battery in FIG. 1;

FIG. 4 is an expanded sectional view of the main part including a high friction shim in FIG. 1;

FIG. 5 is a sectional view showing an example of the high friction shim;

FIG. 6 is a perspective view showing an example of arrangement of the high friction shim;

FIG. 7 is a perspective view showing another example of arrangement of the high friction shim;

FIG. 8 is a graph showing measurement results of a static friction coefficient; and

FIG. 9 is a sectional view of a conventional secondary battery along the laminating direction.

### DETAILED DESCRIPTION OF EMBODIMENTS

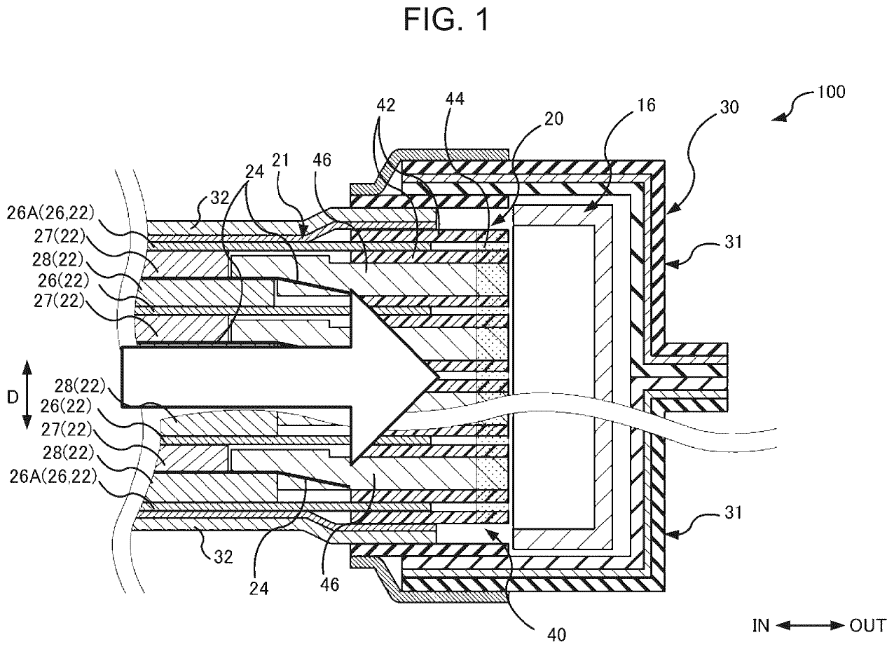

Hereafter, a secondary battery 100 according to an embodiment of the present disclosure will be described with reference to the drawings. FIG. 1 is a sectional view of the secondary battery 100 according to an embodiment of the present disclosure along the laminating direction. Notably, in the description of the drawings, the same signs are used for the same or equivalent elements, duplicate description of which is omitted. Moreover, in the drawings, duplicate signs are occasionally omitted where appropriate. Moreover, in FIG. 1, thicknesses of the constituents and ratios of the thicknesses are exaggerated for ease of the description, and occasionally differ from those in reality.

An example of the secondary battery 100 of the present embodiment is a bipolar secondary battery, and it is used as a battery for various vehicles such as, for example, a forklift, a hybrid electric vehicle, and a battery electric vehicle. The secondary battery 100 is a secondary battery such as, for example, a nickel-metal hydride secondary battery or a lithium ion secondary battery. The secondary battery 100 may be, for example, an electric double layer capacitor.

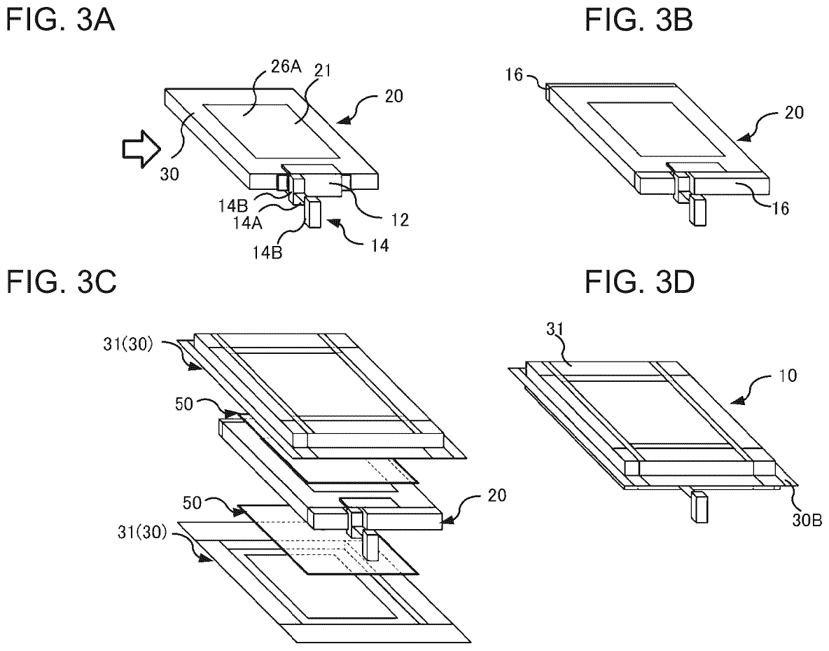

As shown in FIG. 1, the secondary battery 100 includes an electrode module 20 and an exterior member 30 arranged so as to encase the electrode module 20. The electrode module 20 includes an electrode laminated body 21 having a plurality of bipolar electrodes 22 laminated via separators 24, and a seal part 40 arranged so as to enclose the electrode laminated body 21. That is, in the electrode laminated body 21, the separator 24 is interposed between the bipolar electrodes 22 that are adjacent to each other in a laminating direction D. Notably, in the present embodiment, as an example, the electrode module 20 has, for example, a rectangular shape as viewed from the laminating direction (refer to FIG. 3A, FIG. 3B, FIG. 3C, and FIG. 3D).

The bipolar electrode 22 includes a current collector body 26 formed into a rectangular sheet, a positive electrode layer 27 formed on a lower surface in the laminating direction D which is one surface of the current collector body 26, and a negative electrode layer 28 formed on an upper surface in the laminating direction D which is another surface of the current collector body 26. That is, the bipolar electrode 22 is configured by the positive electrode layer 27 and the negative electrode layer 28 being pasted and integrated on both surfaces of the current collector body 26.

Each current collector body 26 is a chemically inactive electric conductor for allowing current to continue to flow in the positive electrode layer 27 and the negative electrode layer 28, for example, during charging or discharging of the secondary battery 100. In the present embodiment, the current collector body 26 is formed of a rectangular metal foil (aluminum foil) composed of Al as an example. As shown in FIG. 1, the positive electrode layer 27 and the negative electrode layer 28 are formed inward of the peripheral edge of the current collector body 26, and a rectangular frame-shaped peripheral edge part of the current collector body 26 is an unapplied region on which the positive electrode layer 27 or the negative electrode layer 28 is not applied.

The positive electrode layer 27 is formed on the lower surface of the current collector body 26, and the negative electrode layer 28 is formed on the upper surface of the current collector body 26. Notably, as to the bipolar electrode 22 that constitutes the lower endmost part of the electrode module 20 in the laminating direction D, the positive electrode layer 27 is not provided on the lower surface. Moreover, as to the bipolar electrode 22 that constitutes the upper endmost part of the electrode module 20 in the laminating direction D, the negative electrode layer 28 is not provided on the upper surface.

That is, in the electrode laminated body 21, the current collector bodies 26 are laminated at both ends (endmost ends) in the laminating direction D, and in the present embodiment, each of these current collector bodies 26 that are laminated at the endmost ends is set as an end part current collector body 26A.

In the electrode module 20, as to the bipolar electrodes 22, the positive electrode layer 27 of one bipolar electrode 22 faces the negative electrode layer 28 of another bipolar electrode 22 that is adjacent via the separator 24 on one side in the laminating direction D. Moreover, in the electrode module 20, as to the bipolar electrodes 22, the negative electrode layer 28 of one bipolar electrode 22 faces the positive electrode layer 27 of another bipolar electrode 22 that is adjacent via the separator 24 on the other side in the laminating direction D.

Each separator 24 is arranged between the bipolar electrodes 22 that are adjacent in the laminating direction D, and is interposed between the positive electrode layer 27 and the negative electrode layer 28. By separating the positive electrode layer 27 and the negative electrode layer 28 from each other, the separator 24 allows charge carriers such as lithium ions to pass through while preventing short circuit due to contact between the adjacent electrode layers. While the separator 24 is formed, for example, into a sheet shape, it may employ a bag shape, not being limited to the sheet-shaped one.

The seal part 40 is formed, at a peripheral edge part of the electrode laminated body 21, into a frame shape so as to enclose the electrode laminated body 21, and includes pairs of holding seal materials 42, an outer peripheral part holding seal part 44, and spacers 46. Each pair of holding seal materials 42 are joined respectively to the peripheral edge parts on the upper surface and the lower surface of the current collector body 26, and hold the current collector body 26 from both sides in the laminating direction D.

As an example, the pair of holding seal materials 42 is formed by a two-layer structure formed by one film being folded into two. That is, a peripheral edge side that is a region where the current collector body 26 is not interposed forms a folded part (bent part) of the film, and at this peripheral edge side, the pair of holding seal materials 42 are joined to each other. Moreover, one surface of surfaces that are opposite to the surfaces facing each other on the pair of holding seal materials 42 is joined to the spacer 46.

Notably, while in the present embodiment, the pair of holding seal materials 42 is constituted of one film, the present disclosure is not limited to this, and they may be constituted of two films.

The outer peripheral part holding seal part 44 holds the outer peripheral parts of the pairs of holding seal materials 42. Specifically, the outer peripheral part holding seal part 44 is a welded layer formed by integrating the pairs of holding seal materials 42 and the spacers 46 mentioned later by welding portions where the pairs of holding seal materials 42 and the spacers 46 mentioned later overlap in the laminating direction.

Each spacer 46 is interposed between two pairs of holding seal materials 42 that are adjacent in the laminating direction D. The spacer 46 holds a gap between the pairs of holding seal materials 42 adjacent in the laminating direction D.

The spacer 46 is formed into a frame shape, and arranged on the peripheral edge part 2 of the current collector body 26 as viewed from the laminating direction D. In the present embodiment, as an example, a peripheral edge part of each separator 24 is pinched and fixed between the spacer 46 and the lower holding seal material 42 of the pair of holding seal materials 42.

For example, the seal part 40 is formed of an insulating resin, and examples of the structure material of the resin include polypropylene (PP), polyphenylene sulfide (PPS), modified polyphenylene ether (modified PPE), and polyethylene (PE). Notably, cover members 16 mentioned later are provided respectively on outer sides of the seal part 40 on the short sides of the electrode laminated body 21.

In the present embodiment, inside the electrode module 20, a plurality of spaces is provided. Each space is provided between the bipolar electrodes 22 that are adjacent in the laminating direction D via the separator 24, being a space that is sealed gastight and liquid-tight by the seal part 40. In this space, an electrolyte solution (not shown), for example, containing a non-aqueous solvent and a supporting electrolyte is housed. The separators 24, the positive electrode layers 27, and the negative electrode layers 28 are impregnated with this electrolyte solution.

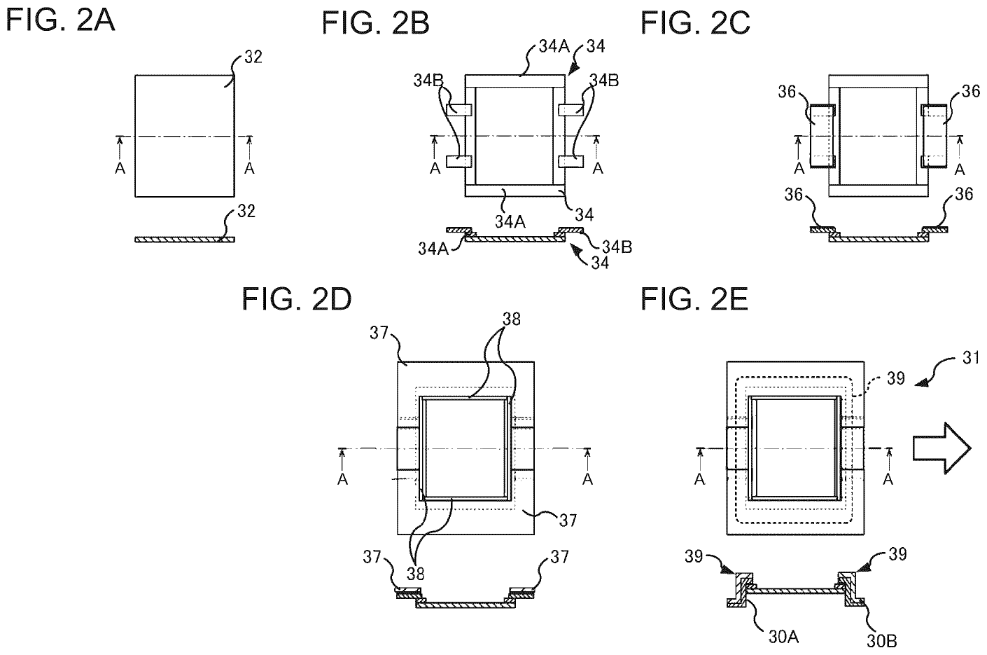

The exterior member 30 is arranged so as to encase the electrode module 20, and is constituted of a pair of exterior bodies 31 each constituted of a laminate film formed by overlapping film materials. In the present embodiment, the exterior member 30, that is, the exterior body 31 is constituted of an aluminum laminate film as an example. Here, an example of a method of forming the exterior body 31 is described. FIG. 2A, FIG. 2B, FIG. 2C, FIG. 2D, and FIG. 2E are explanatory diagrams for explaining forming steps of the exterior body 31 as the exterior member 30 in the secondary battery 100 in FIG. 1. Notably, while a sectional view taken along the A-A line for each of the steps in FIG. 2A, FIG. 2B, FIG. 2C, FIG. 2D, and FIG. 2E is described as a section of one sheet, it shows a laminate film in reality.

As shown in FIG. 2A, first, as an example of a metal layer having conductivity, an aluminum foil 32 with a thickness t=0.1 mm which is rectangular in plan view is placed. Next, as shown in FIG. 2B, as a sealing step, a sealant film 34 that gives scalability through heating is arranged at a peripheral edge part of the aluminum foil 32. As an example, the sealant film 34 is formed by laminating, in the order from the aluminum foil 32 side, a 25-μm acid modified polypropylene (PPa) layer, a 50-μm polypropylene (PP) layer, and a 25-μm PPa layer, and has a thickness of 100 μm. Moreover, the sealant film 34 includes strip-shaped frame parts 34A that are provided on the four sides of the aluminum foil 32, and protruding parts 34B that are provided on both long sides of the aluminum foil 32 so as to protrude from the aluminum foil 32 to be spaced from one another. Each protruding part 34B is provided such that one end overlaps with a part of the frame part 34A and the other end protrudes in the short direction of the aluminum foil 32.

Next, as shown in FIG. 2C, each double-sided laminate film 36 is provided so as to overlap with two protruding parts 34B provided to be adjacent in the longitudinal direction of the aluminum foil 32. The double-sided laminate film 36 is formed into a rectangular shape, has adhesive agents pasted on both surfaces, and is provided such that the longitudinal direction is positioned inward of the adjacent protruding parts 34B. Moreover, as an example, the double-sided laminate film 36 is arranged such that an inner end in the short direction is positioned inward of the protruding part 34B and an outer end substantially coincides with an outer end of the protruding part 34B. As an example, the double-sided laminate film 36 is formed by laminating, in the order from the aluminum foil 32 side, a 70-μm PP layer, a 40-μm aluminum layer, and a 70-μm PP layer, and has a thickness of 180 μm.

Next, as shown in FIG. 2D, two highly molded laminate films 37 each formed into a substantially U-shape having a recess at one end of a rectangular shape are arranged so as to face each other to have a gap in the longitudinal direction of the aluminum foil 32. Each highly molded laminate film 37 is provided such that an inner end part constituting the aforementioned recess portion is positioned slightly more on the outer peripheral side than the inner end of the frame part 34A. Moreover, the highly molded laminate films 37 are arranged such that their end parts that most closely face each other overlap with the protruding parts 34B. As an example, each highly molded laminate film 37 is formed by laminating, in the order from the aluminum foil 32 side, a 30-μm PP layer, a 30-μm PPa layer, an 80-μm aluminum layer, a 25-μm nylon (Ny) layer, an about 1.5-μm adhesive layer, and a 12-μm polyethylene terephthalate (PET) layer, and has a thickness of about 178.5 μm.

Four strip-shaped films 38 for insulation are arranged at boundary portions between the highly molded laminate films 37 and the sealant film 34 (refer to FIG. 2B) so as to go across the relevant boundaries. The materials used for the films 38 for insulation are similar to the aforementioned ones for the sealant film 34.

As shown in FIG. 2E, on the laminate film laminated as above, in an emboss step, a recess part 30A is formed at the center by performing emboss processing along the dotted line indicated by the arrow 39, and a flange part 30B is formed at an outer peripheral edge. Each flange part 30B works as a seal part when the pair of exterior bodies 31 are pasted in the state where they include the electrode module 20.

Next, steps of assembling the exterior member 30 are described. FIG. 3A, FIG. 3B, FIG. 3C, and FIG. 3D are explanatory diagrams for explaining the steps of assembling the exterior member 30 in the secondary battery 100 in FIG. 1. Notably, for the electrode module 20 shown in FIG. 3A, reduced pressure sealing processing and a self-discharge inspection have been already performed.

As shown in FIG. 3A, the electrode module 20 is formed into a substantially rectangular solid shape, and includes a liquid injection port frame 12 in which a liquid injection port (illustration omitted) through which an electrolyte solution mentioned later is injected is formed, and a circuit board part 14 for detecting voltages of the bipolar electrodes 22 constituting the secondary battery 100. The circuit board part 14 includes a flexible printed circuit (FPC) board 14A which is an example of a voltage detection circuit board including a circuit that detects voltage, and the FPC board 14A is held at both ends in one direction by FPC housings 14B. Moreover, in FIG. 3A, FIG. 3B, FIG. 3C, and FIG. 3D, the end part current collector bodies 26A are exposed at the end surface centers of the electrode laminated body 21 in the up-down direction. Notably, on the FPC board 14A, known sealing processing required for sealing with the PP layer of the flange part 30B of the exterior body 31 on the recess part 30A side is performed. In the present embodiment, hereafter, the side on which the circuit board 14 is provided is referred to as a reference short side, and the opposite side to the reference short side is referred to as a counter reference short side.

Next, as shown in FIG. 3B, the hollow cover members 16 are arranged respectively on the reference short side and the counter reference short side of the electrode module 20.

Next, as shown in FIG. 3C, the pair of exterior bodies 31 are assembled from both sides of the electrode module 20 on which the cover members 16 are provided so as to encase the electrode module 20. In this stage, high friction shims 50 as metal members are provided between the electrode module 20 and the exterior bodies 31. As shown in FIG. 1, FIG. 3A, FIG. 3B, FIG. 3C, and FIG. 3D, the high friction shims 50 are provided between the end part current collector bodies 26A which are exposed at the end surface centers of the electrode laminated body 21 in the up-down direction and the aluminum foils 32 at the center parts of the exterior bodies 31. Specifically, as an example, each high friction shim 50 is provided so as to cover the whole surface of the exposed end part current collector body 26A.

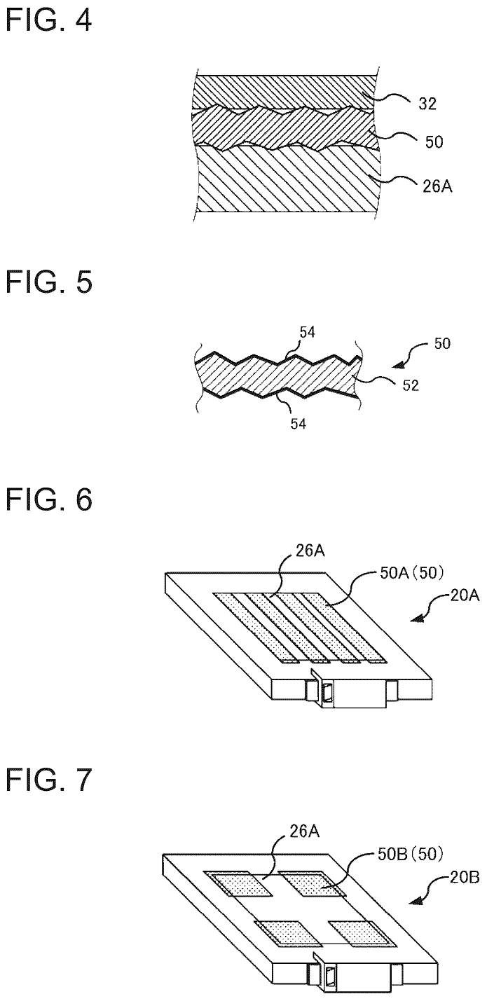

That is, as shown in FIG. 4, the high friction shim 50 is provided between the aluminum foil constituting the end part current collector body 26A and the aluminum foil 32 included in the exterior body 31. The high friction shim 50 is constituted of a metal member that is higher in surface hardness and greater in surface roughness than the surface of the aluminum foil 32. Specifically, as an example, as shown in FIG. 5, the high friction shim 50 includes a stainless steel foil 52 having polishing processed layers on surfaces on both sides in the thickness direction, and surface hardening layers 54 provided on surfaces of the stainless steel foil 52 on both end sides in the thickness direction.

The polishing processed layers on the stainless steel foil 52 are formed by performing blasting processing on the surfaces on both sides in the thickness direction. In the blasting processing, a surface roughness of the stainless steel foil 52 is increased by jetting a fine abrasive compound or the like from a blasting apparatus (illustration omitted). Notably, for the polishing processed layers, not being limited to the blasting processing, for example, etching processing can also be used. Also by the etching processing, the surface roughness can be increased, and hence, a friction force on the contact surface can be made high. Moreover, as an example, the surface hardening layers 54 are formed by coating the polishing processed layers of the stainless steel foil 52 with tungsten, which has high hardness in general.

Next, as shown in FIG. 3D, the flange parts 30B of the pair of exterior bodies 31 are overlapped and joined together. In this stage, as shown in FIG. 3A, FIG. 3B, FIG. 3C, and FIG. 3D, the flange parts 30B are arranged so as to be positioned on the FPC board 14A. In the present embodiment, the surfaces of the flange parts 30B of the pair of exterior bodies 31, the surfaces facing each other, are constituted of PP layers. A method of joining PP layers together is not specially limited, and a known method can be used. Specifically, for example, a hot plate welding method, an ultrasonic welding method, a vibration welding method, a laser welding method, or the like, adhesion with an adhesive agent, and the like can be used.

Next, operation and effects of the secondary battery 100 in the first embodiment are described.

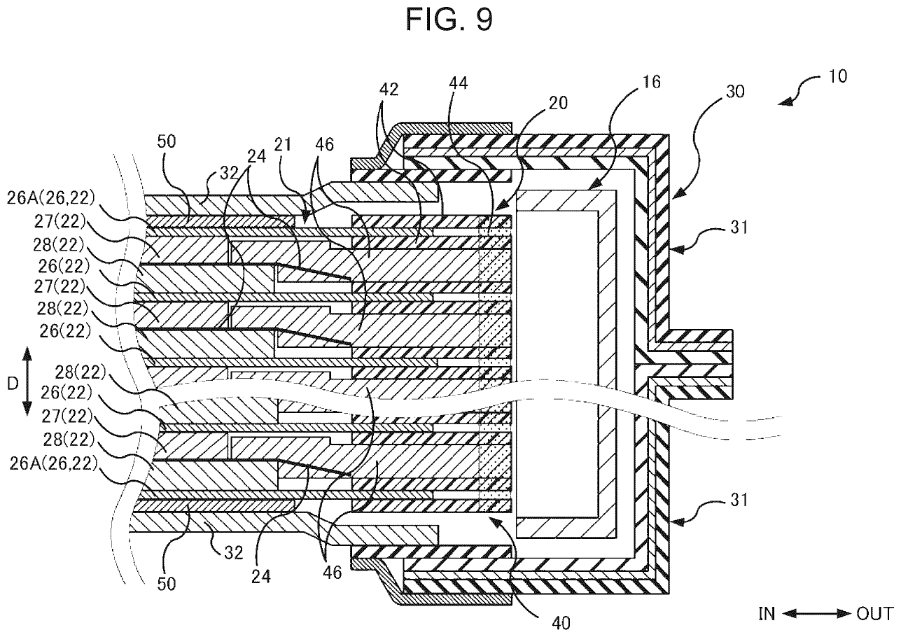

Here, FIG. 9 shows a sectional view, corresponding to FIG. 1, of a secondary battery 10 of the related art. Notably, in FIG. 9, the similar members to those in FIG. 1 are shown with the same signs, their description is herein omitted, and only different structures are described in detail.

As to the related secondary battery 10, there is a possibility that the electrode module 20, together with the cover members 16, moves inside the exterior member 30 due to an inertial force (the void arrow in FIG. 9) caused by vibration and impact in the horizontal direction. If the electrode module 20 moves together with the cover members 16 inside the exterior member 30, it could cause damage to the exterior member 30.

In the secondary battery 100 of the present embodiment, the high friction shims 50 are arranged between the electrode module 20 and the exterior member 30 encasing the electrode module 20. Each high friction shim 50 is a metal member that is higher in surface hardness and greater in surface roughness than the end part current collector bodies 26A (aluminum foils) constituting the outer surfaces at both ends of the electrode laminated body 21 of the electrode module 20 in the laminating direction D and the aluminum foils 32 constituting the inner surface of the exterior member 30. Therefore, by convexities and concavities on the surfaces of the high friction shims 50 eating into the end part current collector bodies 26A (aluminum foils) of the electrode module 20 and the aluminum foils 32, friction forces on contact surfaces with the surfaces of the high friction shims 50 can be increased as compared with the case of no interposition of the high friction shims 50. Thereby, movement of the electrode module 20 inside the exterior member 30 can be restrained. Moreover, since the outer surface of the electrode module 20 is not processed, surface processing that is normally performed on the electrode module 20 is not affected.

Moreover, conventionally, when in a secondary battery having bipolar electrodes, end part current collector bodies are composed of, for example, Al, corrosion prevention processing and/or processing for improving sealing strength are performed on Al surfaces which are outer surfaces of the end part current collector bodies. For the electrode module having the bipolar electrodes, differently from an electrode module having a typical electrode laminated body, static friction resistance between the electrode module and the exterior member is needed to be increased while an electrification function of the principal surfaces of the end part current collector bodies is secured. For example, there is a possibility that the processing as above performed on the Al surfaces is affected in some way when processing for increasing the static friction resistance is performed on the Al surfaces for the electrode module having the bipolar electrodes.

Therefore, in the secondary battery 100 of the present embodiment, the electrode laminated body 21 is configured by laminating the bipolar electrodes 22 via the separators 24, and the electrode module 20 includes the end part current collector bodies 26A laminated respectively at both ends of the electrode laminated body 21 in the laminating direction D. Therefore, the high friction shims 50 provided between the electrode module 20 and the exterior member 30 can increase friction forces between the surfaces of the high friction shims 50 and both the outer surfaces of the end part current collector bodies 26A and the inner surfaces of the aluminum foils 32 of the exterior member 30. Thereby, movement of the electrode module 20 inside the exterior member 30 can be restrained without an electrification function on the principal surfaces of the end part current collector bodies 26A being disturbed.

Moreover, in the secondary battery 100 of the present embodiment, the aluminum foil 32 which is an inner film, of the laminate film forming the exterior member 30, that is on the electrode module 20 side and the end part current collector body 26A are constituted of an equivalent material, that is, aluminum foils. Nevertheless, since the high friction shim 50 is provided between the aluminum foil 32 and the end part current collector body 26A, by convexities and concavities on the surfaces of the high friction shim 50 cating into the outer surface of the end part current collector body 26A and the aluminum foil 32, the friction forces on the contact surfaces with the surfaces of the high friction shim 50 can be increased. Thereby, movement of the electrode module 20 inside the exterior member 30 can be restrained.

Moreover, in the secondary battery 100 of the present embodiment, since the stainless steel foil 52 constituting the high friction shim 50 has the polishing processed layers on its surfaces, rough surfaces having convexities and concavities can be formed on the surfaces of the high friction shim 50. Moreover, since the high friction shim 50 has the surface hardening layers 54 on the surfaces of the stainless steel foil 52, the aforementioned surfaces having convexities and concavities are hardened, and the convexities and concavities of the high friction shim 50 can be made readily eat into the outer surface of the end part current collector body 26A and the aluminum foil 32 of the exterior member 30.

Moreover, in the secondary battery 100 of the present embodiment, since the high friction shims 50 are provided on the whole outer surfaces of the exposed end part current collector bodies 26A, movement of the electrode module 20 inside the exterior member 30 can be more effectively restrained.

Notably, in the present embodiment, as shown in FIG. 3A, FIG. 3B, FIG. 3C, and FIG. 3D, each high friction shim 50 is provided so as to cover the whole surface of the exposed end part current collector body 26A, the present disclosure not being limited to this. For example, as shown in FIG. 6, in the electrode module 20A, the high friction shim 50 may be formed of four shims 50A each formed into a long strip shape, and may be arranged in parallel such that the longitudinal direction of the four shims 50A is parallel to the longitudinal direction of the exposed end part current collector body 26A.

Moreover, as shown in FIG. 7, in the electrode module 20B, the high friction shim 50 may be formed of four shims 50B each formed into a substantially square shape, and the four shims 50B may be arranged at four corners of the exposed end part current collector body 26A.

As above, by arranging the high friction shim 50 on a part of the exposed end part current collector body 26A, costs required for the high friction shim 50 can be reduced.

Center line average roughnesses Ra and maximum height roughnesses Rz on surfaces of the aforementioned high friction shim 50 of the embodiment and an aluminum foil as a comparative example were measured. The center line average roughness Ra and the maximum height roughness Rz corresponded to the surface roughness of the present disclosure. Notably, a carbon coating was provided on the surface of the aluminum foil as with the aluminum foil 32 of the exterior member 30 and the aluminum foil constituting the end part current collector body 26A. For the measurement, a laser microscope with a white light interferometer (VK-X3000, Keyence Corporation) was used to obtain the surface roughnesses Ra, Rz on the surfaces. The lens used was 10×, and the measurement region employed a condition of 1 mm×1.5 mm. Table 1 presents the results.

TABLE 1

| | |
|---|---|
| High Friction Shim | Aluminum Foil |

| | | | | |
|---|---|---|---|---|
| Ra | 5.77 | μm | 0.403 | μm |
| Rz | 41.7 | μm | 3.6 | μm |

As presented in Table 1, the high friction shim 50 of the present embodiment afforded greater values than the aluminum foil in terms of both the center line average roughness Ra and the maximum height roughness Rz. That is, the high friction shim 50 of the present embodiment was greater in surface roughness than the aluminum foil 32 of the exterior member 30 and the aluminum foil constituting the end part current collector body 26A.

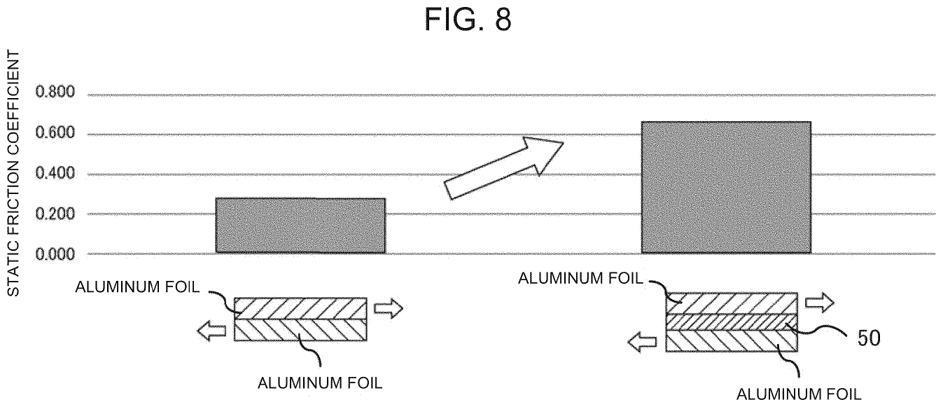

Moreover, using the aforementioned high friction shim 50 of the embodiment and the aluminum foil used in the aforementioned measurement of the surface roughness, static friction coefficients were measured. FIG. 8 is a graph showing the measurement results of the static friction coefficients. As shown in FIG. 8, as a comparative example, a static friction coefficient μ in the case of overlapping the aluminum foils was measured. The measurement was performed by exerting forces in the right and left directions in the state where the aluminum foils were overlapped to measure a maximum static friction force F, which is a friction force immediately before the start of movement of the aluminum foils. The static friction coefficient μ was calculated based on equation (1) below from the measured maximum static friction force F and a normal force N corresponding to the weight of the aluminum foil, and this static friction coefficient μ in the comparative example was 0.280.

$$F = μ N \qquad ( 1 )$$

Meanwhile, a static friction coefficient μ in the case where the high friction shim 50 was provided between aluminum foils for the structure of the present embodiment was measured. The measurement was performed by exerting forces on upper and lower aluminum foils in the right and left directions in the state where the aluminum foil, the high friction shim 50, and the aluminum foil were sequentially overlapped to measure the maximum static friction force F, which is a friction force immediately before the start of movement of the aluminum foils. The static friction coefficient μ was calculated based on equation (1) above from the measured maximum static friction force F and the normal force N corresponding to the weight of the aluminum foil, and this static friction coefficient μ was 0.666. That is, as compared with that of the comparative example, the structure of the present embodiment afforded about 2.4 times the value of the static friction coefficient μ. Accordingly, as compared with that of the comparative example, the structure of the present embodiment was able to increase the friction force on the contact surface.

### Supplementary Explanation

Notably, while in the aforementioned embodiment, the electrode module 20 includes the electrode laminated body 21 having the bipolar electrodes 22 laminated, the present disclosure is not limited to this, and the electrode module 20 may include a typical electrode laminated body not having the bipolar electrodes 22, that is, an electrode laminated body having a plurality of cells laminated. In this case, a metal member provided between a case constituting cells at both ends in the laminating direction and the exterior member 30 is a member that is higher in surface hardness and greater in surface roughness than the outer surface of the case and the inner surface of the exterior member.

Moreover, while in the aforementioned embodiment, the high friction shim 50 as the metal member includes a stainless steel foil, the present disclosure is not limited to this, and it may contain a metal other than stainless steel, and in place of the stainless steel foil, may include, for example, a titanium foil or the like.

Moreover, while in the aforementioned embodiment, the high friction shim 50 as the metal member has the surface hardening layers 54 formed by coating the polishing processed layers of the stainless steel foil 52 with tungsten, the surface hardening layers 54 are not limited to tungsten. The surface hardening layers 54 may be any material as long as they are composed of a material that is higher in surface hardness than the outer surfaces at both ends of the electrode laminated body 21 of the electrode module 20 in the laminating direction and the inner surface of the exterior member 30.

Moreover, while in the aforementioned embodiment, the aluminum foils 32 forming the inner surface of the laminate film constituting the exterior member 30 and the aluminum foils constituting the end part current collector bodies 26A are composed of an equivalent material, the present disclosure is not limited to this, and they may be different materials.

Moreover, while in the aforementioned embodiment, the laminate film and the sealant film constituting the exterior member 30 have the aforementioned configurations, the present disclosure is not limited to these, and the materials may be modified as appropriate.

Moreover, a configuration of the present disclosure is not limited to that in the aforementioned embodiment, and the configuration may be modified as appropriate as long as the problem is able to be solved.

What is claimed is:

1. A secondary battery comprising:
an electrode module including
an electrode laminated body having a plurality of positive electrode layers and a plurality of negative electrode layers laminated via a separator;
an exterior member encasing the electrode module; and
a metal member that is higher in surface hardness and greater in surface roughness than an outer surface at both ends of the electrode laminated body of the electrode module in a laminating direction and an inner surface of the exterior member, the metal member being provided between the electrode module and the exterior member.

2. The secondary battery according to claim 1, wherein:
the electrode laminated body is configured by laminating a plurality of bipolar electrodes via the separator, each bipolar electrode having the positive electrode layer provided on one surface of a current collector body and the negative electrode layer provided on another surface of the current collector body; and
the electrode module includes end part current collector bodies laminated respectively at both ends of the electrode laminated body in the laminating direction.

3. The secondary battery according to claim 2, wherein the metal member is provided between at least part of the end part current collector body and the exterior member.

4. The secondary battery according to claim 1, wherein:
the exterior member is a laminate film obtained by overlapping film materials; and
an inner film, of the laminate film, that is on the electrode module side and the outer surface at both ends of the electrode laminated body in the laminating direction are constituted of an equivalent material.

5. The secondary battery according to claim 1, wherein
the metal member has
a metal foil having a polishing processed layer on a surface, and
a surface hardening layer provided on a surface, of the metal foil, that is on both end sides in a thickness direction.
